(19) United States
(12) Patent Application Publication
(10) Pub. No.: US 2009/0097817 A1
(43) Pub. Date: Apr. 16, 2009

(54) MULTIPLE-INPUT VIDEO-IMAGE MERGING SYSTEM

(75) Inventor: Henning Dollerup BACH, Struer (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Bang & Olufsen A/S, Struer (DK)

(21) Appl. No.: 12/118,088

(22) Filed: May 9, 2008

(30) Foreign Application Priority Data
May 10, 2007 (DK) PA 2007 00710

(51) Int. Cl. H04N 5/04

(52) U.S. Cl. 386/66

(57) ABSTRACT

In order to prevent shudder and other artifacts when combining images from, e.g., TV and PC sources, a frame-synchronized alpha merging output from a separate unit is provided.

### BACKGROUND OF THE INVENTION

1. Field of the Invention

The invention relates to a system for seamless merging of TV screen images from personal computers and video sources.

2. Description of Related Art

Generally speaking, today's TV and video systems can be categorized in two categories:
(1) TV/Set Top Box centric systems from the traditional consumer electronics manufacturers.
(2) PC/Media Centre centric systems from the IT/PC industry.

In (1), the PC is a signal source to the TV set. The PC can be physically integrated in TV set or it can be external. The PC can run software applications such as web-browsing, email, shopping, photo, music, etc. However, the software applications on the PC are available to the user only after a so-called source selection. During such a source selection, the TV set normally blanks the screen while the re-synchronization to the video/graphics output from the PC takes place. In (1) the video/graphics generated by the PC is not seamless integrated (merged or blended on a pixel to pixel basis) with the video and graphics from the other signals sources to the TV set.

In (2), the TV tuner is integrated in the PC. This gives a seamless integration of all graphics and video. However, performing video processing in the PC often results in a reduced picture quality. For instance, the frame rate of NTSC is 59.94 Hz while most Media Centre PCs runs at 60 Hz. This difference in frequency results in a periodic shudder phenomenon.

The TV and video systems in both categories hence have certain lacks in performance due to the signal architectures.

Furthermore, some video signals are content protected with an encryption scheme which does not allow the content protected video signals to be processed in an open architecture, such as the PC architecture. HDCP (High-bandwidth Digital Content Protection) is an example of such a content protection.

### SUMMARY OF THE INVENTION

It is the purpose of the present invention to avoid the above indicated performance deficiencies by combining the signal architectures in (1) and (2) in a novel way by which the advantages in picture quality of traditional TV-architecture is combined with the video and graphics advantages of the PC-architecture. The proposed architecture is characteristic in that a unit comprising a frame synchronizer and an alpha blending circuit is supplied with signals from a TV chassis providing a video output and a sync/clock output as well as with signals from a personal computer providing an RGB/alpha output as well as a sync/clock output, said unit providing a combined video/sync signal to a video-type screen.

The architecture according to the invention makes it possible for the software applications which run on the PC to alpha blend their video and graphics output into the video signal path of a traditional TV-architecture. The strength of using alpha blending is that the signals is combined in a very seamless way as were they generated by the same source.

According to the invention, the output to the screen may be synchronized from the TV chassis or from the PC as the case may be. Expressed differently, both the TV chassis and the PC may assume the role of sync master. The source which is not the sync master will be the sync slave. The video output from the sync slave is synchronized to the sync master by frame synchronization.

Regarding the internal architecture of the frame buffer/memory, different architectures can be applied. These architectures include single buffer systems as well as multiple buffer systems which implement buffer swapping and swap chains. The frame synchronization could also include frame rate conversion including more advanced methods such as motion estimation and motion compensation.

The architecture according to the invention has the following advantages

The video/graphics output of a TV-architecture and the video/graphics output of a PC-architecture can be merged using alpha blending on a pixel to pixel basis.

A TV-architecture and a PC-architecture can be seamlessly merged using alpha blending without doing compromises which sacrifice picture quality.

PC graphics can be fed into the video signal path of a TV set without doing a source selection and without doing a re-synchronization of the attached screen during which the screen is blanked.

PC software applications that utilize the proposed architecture with alpha blending can be developed.

Content protected video which are not allowed to be processed in a PC or another open architecture (for instance HDCP content) can be seamless integrated with graphics generated by the PC by using alpha blending.

The TV architecture can either be the sync master or the sync slave, all according to need or convenience.

The PC architecture can either be the sync master or the sync slave, all according to need or convenience.

Different methods of frame synchronization can be applied for synchronizing the video/graphics output of relatively the TV architecture and the PC architecture. The TV architecture and the PC architecture can be kept separated as two complete domains without doing any compromises in one domain for the sake of the other domain.

The best performing TV architecture and components can be chosen freely without any trade off in relation to the chosen PC.

The best performing PC can be chosen freely without any trade off to the chosen TV architecture and components.

The invention will be further described with reference to the drawing, in which

### BRIEF DESCRIPTION OF THE DRAWINGS

FIG. 1 is a block diagram of a PC used as an external source to the TV architecture in accordance with the prior art,

FIG. 2 is a block diagram of a TV tuner integrated into the PC architecture in accordance with the prior art,

FIG. 3 is a block diagram of an architecture according to the invention, and

FIG. 4 is a block diagram that shows a typical method for frame synchronization of two video sources

### DETAILED DESCRIPTION OF THE INVENTION

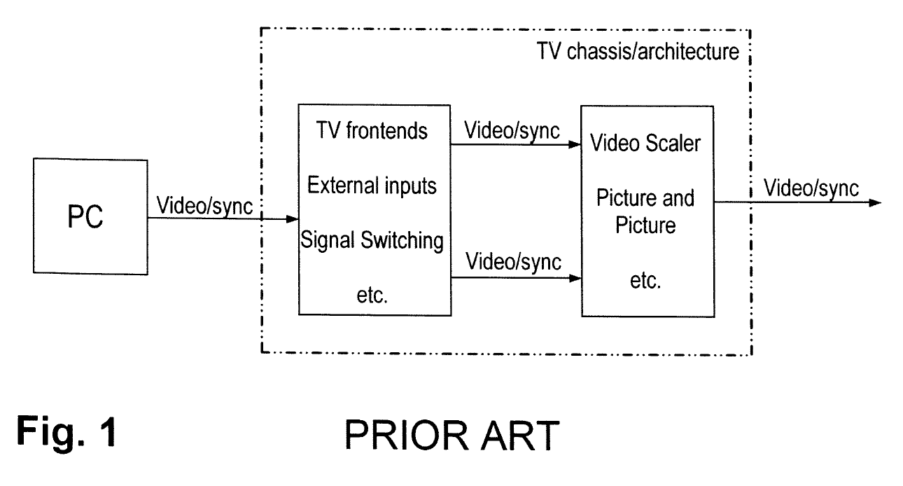

FIG. 1 shows a prior art solution with a PC as a signal source to the TV set.

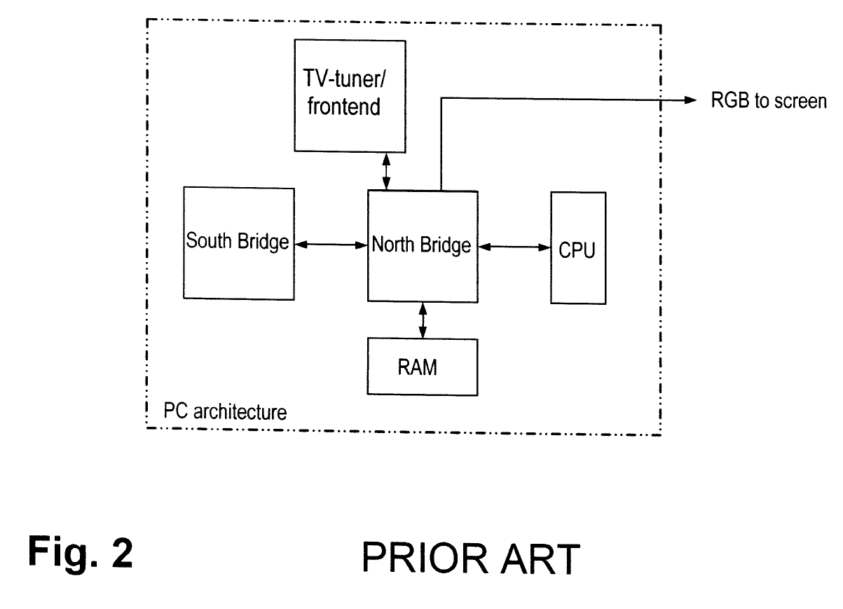

FIG. 2 shows an alternative prior art solution with a TV tuner being integrated into the PC architecture.

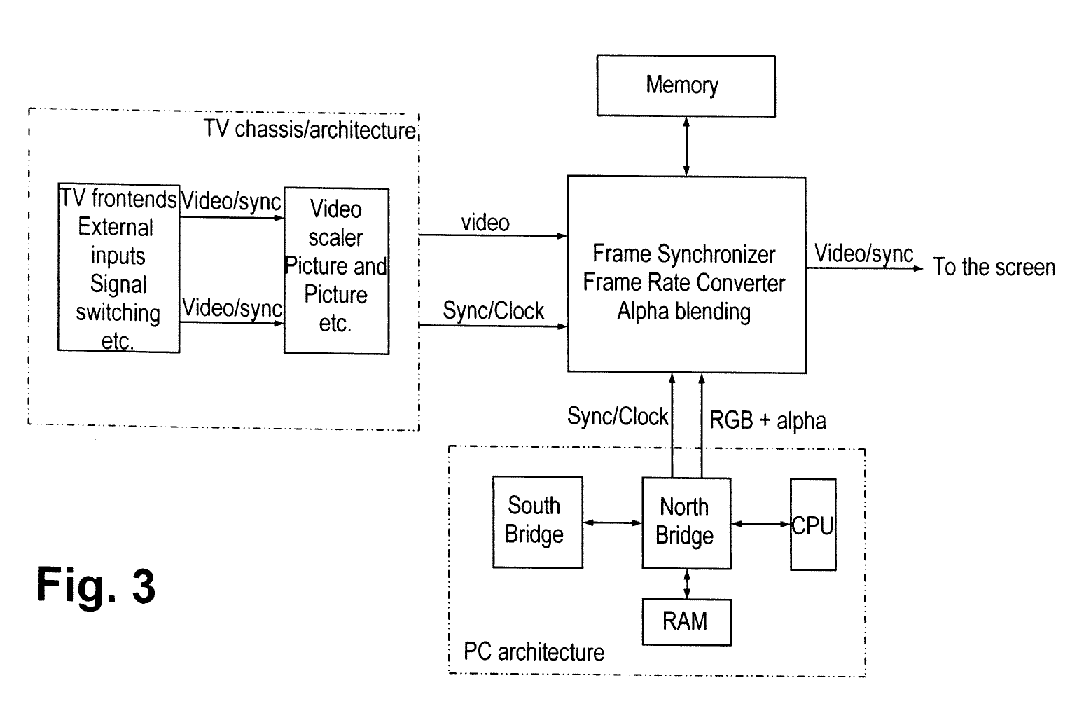

FIG. 3 shows a block diagram according to one embodiment of the invention. A TV chassis and a personal computer both display the architectures that are well-known. Each source provides output signals to a unit that acts as a combiner and blender of the respective output images.

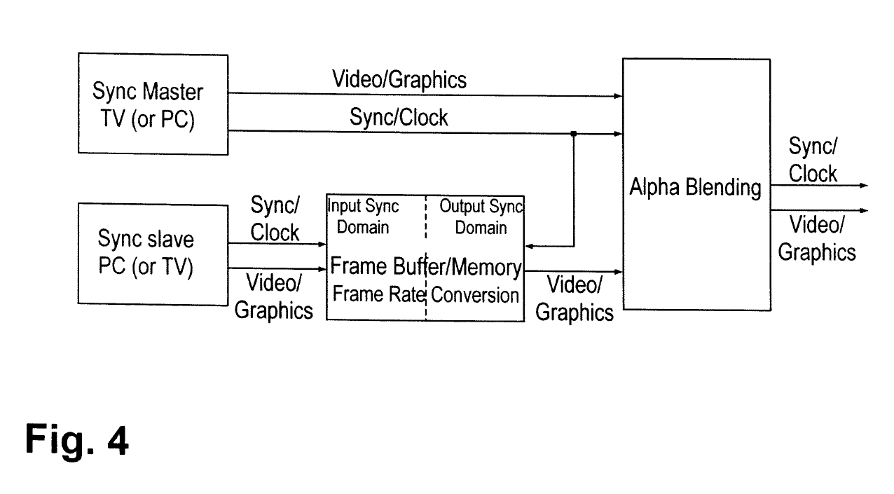

FIG. 4 shows a typical method for doing frame synchronization of two video/graphics signals. The video/graphics signal from the sync slave is fed into a memory (frame buffer). When outputting the video/graphics from this memory (frame buffer) the video/graphics output is synchronized from the sync master. As a result the two video/graphics signals are synchronized and can be applied for alpha blending.

What is claimed is:

1-5. (canceled)

6. A system for seamless merging of TV screen images from personal computers and video sources, comprising:
a TV chassis providing a video output and a sync/clock output as well as with signals
a personal computer providing an RGB/alpha output as well as a sync/clock output,
a unit having a frame synchronizer and an alpha blending circuit,
wherein the unit is connected to the TV chassis for receiving said signals therefrom and to the personal computer for receiving said outputs thereof, and
wherein said unit provides a combined video/sync signal to a video-type screen.

7. A system according to claim 6, wherein the TV chassis output is taken as a sync master and wherein the output of the personal computer is synchronized as a sync slave to the sync master by frame synchronization.

8. A system according to claim 6, wherein the personal computer output is taken as a sync master and wherein the output of the TV chassis is synchronized as a sync slave to the sync master by frame synchronization.

9. A system according to claim 6, wherein the unit further comprises a frame rate converter circuit.

10. A system according to claim 9, wherein a memory unit is associated with the unit.
